(19) United States
(12) Patent Application Publication
(10) Pub. No.: US 2026/0257242 A1
(43) Pub. Date: Sep. 3, 2026

(54) COATING DISPENSING APPARATUS AND COATING COMPOSITION

(71) Applicant: PPG Industries Ohio, Inc., Cleveland, OH (US)

(72) Inventors: Jun Deng, Mars, PA (US); Daniel Vile, Stowmarket (GB)

(73) Assignee: PPG Industries Ohio, Inc., Cleveland, OH (US)

(21) Appl. No.: 19/489,942

(22) PCT Filed: May 29, 2024
(86) PCT No.: PCT/US2024/031351

§ 371 Date: Dec. 4, 2025

Related U.S. Application Data
(60) Provisional application No. 63/507,323, filed on Jun. 9, 2023.

(51) Int. Cl. B05D 7/14; B05D 7/02; G06Q 10/087

(52) U.S. Cl. CPC B05D 7/142; B05D 7/02; G06Q 10/08741; B05D 2501/00

(57) ABSTRACT

A computer-implemented (and apparatus implementing the method), can include receiving a set of coating variables comprising: (i) data corresponding environmental input corresponding to local environmental data located adjacent a coating application area, and (ii) one or more end-user supplied application variables for applying a coating. The method can also include, based upon the received coating variables, identifying (i) a subset of reagents, including at least a polymer reagent, (ii) one or more additional reagents, (iii) a dosing ratio for the same. In addition, the method can include identifying, based upon the received coating variables, a first ratio of polymer reagent to use in the subset of reagents. Furthermore, the method can include determining a volume of reagents to dispense, wherein the volume depends on the received coating variables. Still further, the method can include, upon confirmation, dispensing an effective amount of each identified reagent in the determined volume.

### CROSS-REFERENCE TO RELATED APPLICATIONS

The present disclosure claims the benefit of priority to U.S. Provisional Application No. 63/507,323, filed on Jun. 9, 2023, the entire content of which is incorporated herein by reference.

### BACKGROUND

### 1. Field

The present disclosure relates to devices, computer-implemented methods, and systems for providing coating reagents for eventual application.

### 2. Background

Coating manufacturers generally provide coatings as mixed reagents in certain preset volumes that are ready to apply. For example, a coating manufacturer may provide a retail store with several sets of premixed coatings in sealed containers where the end user need apply the coating, or manually add another reagent such as a hardener and then apply the coating to the given object. In some cases, the user can then save the remaining, unused volume for later applications, whereas some mixtures may immediately begin to denature if not applied quickly and hence need to be discarded after completion of a project. In industrial settings, the coating manufacturer may similarly provide the coating mixed, or unmixed, and the industrial user may use various equipment to properly mix the toners and bases before applying the coating. In general, most conventional coatings in the form of basecoats, or color layers can be mixed in advance and later stored without much difficulty. On the other hand, the sheer number and variety of possible colors, shades, and finishes, can create inventory problems for maintaining an appropriate level of coating reagents, toners, or other additives.

Adding to the foregoing difficulties is that there are many coating products available that can meet different needs in refinish body shops, which can result in high variance in complexity of mixture, as well as variance in success of outcome. The selection and mixing process may be particularly challenging for a less skilled worker. To accommodate the different preferences and mixing abilities, there may be a need to for a wider variety of coating reagents to maintain in inventory. While these inventory issues can be difficult for both large-scale and small-scale application environments, such inventory issues may be particularly acute for smaller body shops, which may have fewer resources for managing coating inventory, and in turn may be much more sensitive to the costs of waste.

Accordingly, there are a number of difficulties in the art that can be addressed.

### SUMMARY

The present disclosure provides systems, methods, and computer program products that enable robust inventory management and delivery of coatings of all types, including clearcoats. For example, the present disclosure includes a dispenser apparatus that can prepare coating reagents for a nearly endless range of expected properties, as applicable for the given type of coating, and can do so with a relatively limited inventory on hand. Upon receipt of various parameters for a particular application, the dispensing machine can dispense a customized set of ingredients to an end user. The end user can then receive the customized reagents from the dispenses in either a mixed or unmixed state, and use the provided reagents as outlined with high degree of confidence in the resulting finish while minimizing waste.

For example, a computer-implemented method (and corresponding dispensing apparatus for performing the same) can include receiving, by a computing system, a set of coating variables comprising: (i) data corresponding environmental input corresponding to local environmental data located adjacent a coating application area, and (ii) one or more end-user supplied application variables for applying the coating to an object. The method can also include, based upon the received coating variables, identifying, by the computing system, (i) a subset of reagents, including at least a polymer reagent for applying a coating to an object, (ii) one or more additional reagents, (iii) a dosing ratio for each identified reagent in the subset. In addition, the method can include identifying, by the computing system, based upon the received one or more coating variables, a first ratio of polymer reagent to use in the subset of reagents. Furthermore, the method can include determining, by the computing system, a volume of the subset of reagents to dispense, wherein the volume depends on the received environmental data for the paint application area, and the one or more end-user supplied application variables; upon receipt of user confirmation, dispensing through the dispenser apparatus, an effective amount of each identified reagent of the subset and in the determined volume.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims, or may be learned by the practice of the examples as set forth hereinafter.

### BRIEF DESCRIPTION OF THE DRAWINGS

To describe the manner in which the above-recited and other advantages and features can be obtained, a more particular description of the subject matter briefly described above will be rendered by reference to specific examples which are illustrated in the appended drawings. Understanding that these drawings depict only typical examples and are not therefore to be considered to be limiting in scope, examples will be described and explained with additional specificity and detail through the use of the accompanying drawings in which:

FIG. 1 illustrates a schematic of a system for dispensing customized coating reagents for use with coating application apparatus in accordance with the present disclosure;

FIGS. 2A, 2B, and 2C illustrate a sequential schematic in which the dispensing apparatus in FIG. 1 dispenses customized coating reagents for use in a coating application;

FIG. 3 illustrates another schematic of the dispensing machine of FIGS. 1 and 2A-2C, in which the dispensing machine dispenses ingredients for use in a coating application;

FIG. 4 illustrates a flowchart of a decision tree for use in determining and delivering one or more applicable coating reagents; and

FIG. 5 illustrates an additional or alternative computer-implemented method for use in determining and dispensing coating reagents in response to environmental variables and user preferences.

### DETAILED DESCRIPTION

The present disclosure provides systems, methods, and computer program products that enable robust inventory management and delivery of coatings of all types, including clearcoats. For example, the present disclosure includes a dispenser apparatus that can prepare coating reagents for a nearly endless range of expected properties, as applicable for the given type of coating, and can do so with a relatively limited inventory on hand. Upon receipt of various parameters for a particular application, the dispensing machine can dispense a customized set of ingredients to an end user. The end user can then receive the customized reagents from the dispenses in either a mixed or unmixed state, and use the provided reagents as outlined with high degree of confidence in the resulting finish while minimizing waste.

In particular, as will be understood more fully herein from the following specification and claims, the present disclosure provides one or more solutions that enable satisfaction of different coating reagent preferences, appropriately adjusted for a local application environment, and adjusted for a given end-user without overwhelming inventory and other resource concerns. This can be accomplished at least in part though highly tailored coating reagents delivered in an essentially on-demand format, and with a wide range of available attributes in the finished product.

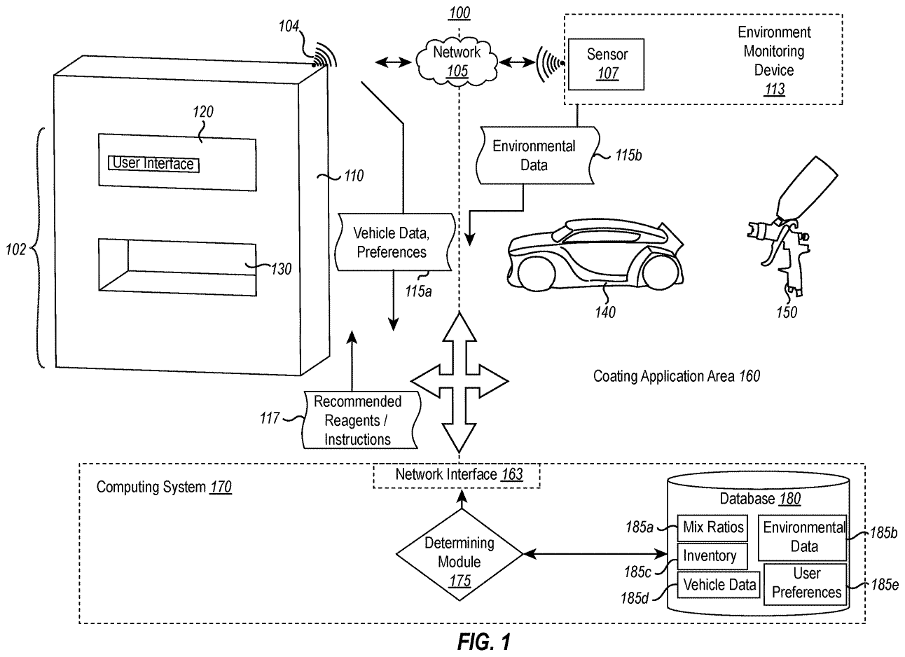

In one example, a coating system, such as a clearcoat or other coating system, may comprise a plurality of different types of resin/polymer reagents with favorable stability. Resin reagents, for example, can contain one or more unique resins, along with ultra-violet absorbers (UVA)/or Hindered Amine Light Stabilizers (HALs) additives and solvents to reach viscosity around 500 centipoise (cP). The several unique resins can include a wide range of resins with differing polymer properties, including differing by Mw, Tg, functionality and reactivity. A dispensing apparatus (e.g., 110, FIG. 1) can select the most appropriate resin/polymer reagents for a given situation, and provide the resin reagents in customized volumes/amounts and mixtures, as needed for a given operating condition.

In addition, the present disclosure can include providing, through the dispensing machine (110) a wide range of additional reagents for use with a polymer reagent, such as crosslinker reagents in the case of coatings in the form of clearcoats. Crosslinker reagents may contain unique types of crosslinkers along with solvents in order to similarly reach viscosities around 500 cP, or other desired attributes of application or finish. Several unique crosslinkers may be utilized to cover wide ranges of crosslinker properties, also including Mw, Tg, functionality and reactivity. A dispensing apparatus (e.g., 110, FIG. 1) can provide the crosslinker reagents in various volumes and mix ratios, along with any other additives. A dispensing apparatus (e.g., 110), discussed more fully herein, can hold physical containers of various types of crosslinker reagents, and dispense the crosslinkers in the relevant amounts needed.

Still further, the present disclosure can provide for the use of a number of catalyst reagents and differing types thereof. Each catalyst reagent, in turn, may comprise a solution further comprising one or more catalysts, catalyst modulators, inhibitors and solvents. The concentration of catalyst in the reagents may range from 1% to 100%. Yet still further, the present disclosure can provide a number of reducer reagents, and multiple different types thereof. Each reducer reagent likewise may comprise one or more solvents with a specific range of physical properties, such as relative evaporation rate, and Hansen solubility parameters.

As before, a dispensing apparatus (e.g., 110, FIG. 1) can store the various catalyst or reducer reagents in various physical containers, which may comprise sealed containers in various different volumes that the dispenser accesses to dispense certain amounts to an end-user. That is, a dispensing apparatus (e.g., 110), discussed more fully herein, can hold the physical containers of catalyst or reducer reagents, and provide them in the relevant amounts needed. The dispensing machine 110 and corresponding system 100 (including a computing system 170) can manage each of these different reagents to eliminate guesswork or other errors through systems and processes that enable providing of appropriate reagents in correct amounts. This can ensure users are always using the right products and in the right amounts, thereby maximizing productivity while minimizing waste.

As an initial matter, for purposes of understanding aspects of the present disclosure, it will be understood herein that the articles “a” or “an” can include “one or more.” That is, although the disclosure may be presented in terms of ‘a’ feature, ‘an’ element, and the like, one or more of any of these components or other recited components can be used according to the present disclosure. In addition, as used herein, the terms “executable module,” “executable component,” “component,” “module,” or “engine” can refer to hardware processing units or to software objects, routines, or methods that may be executed on computer system 100. The different components, modules, engines, and services described herein may be implemented as objects or processors that execute on computer system 100 (e.g. as separate threads).

In general, “modules” and “components” will be understood as abstractions of generalized processing components that can be used in at least one implementation of the present disclosure, and there may be more or fewer than those illustrated and described, and as may be suited for a particular server and cloud operating environment. As used herein, a “module” means computer executable code that, when executed by one or more processors at a given computer system (e.g., computer system 170), cause the given computer system to perform a particular function. By contrast, a “component” means a passive set of instructions or data structures or records that store, manage, and/or otherwise provide information handled through a given module. One of skill in the art, however, will appreciate that the distinction between a different modules or components is at least in part arbitrary, and that modules or components may be otherwise combined and divided and still remain within the scope of the present disclosure. As such, the description of a component as being a “module” or a “component” is provided only for the sake of clarity and explanation and should not be interpreted to indicate that any particular structure of computer executable code and/or computer hardware is required, unless expressly stated otherwise. In this description, the terms “component,” “agent,” “manager,”“service,” “engine,” “virtual machine” or the like may also similarly be used.

Turning now to the Figures, FIG. 1 illustrates a schematic of a system 100 for dispensing, or otherwise delivering in response to a user request, coating reagents for use with coating application apparatus in accordance with the present disclosure. For example, FIG. 1 shows that system 100 comprises a dispensing machine (or dispensing apparatus) 110 having a body or frame 102, a user interface 120 (provided via computing system 170), and a delivery section 130. FIG. 1 also shows that dispensing apparatus 110 can communicate over a network 105 via a network component 104, such as the illustrated wireless connection interface.

One will appreciate, however, that the network component 104 can additionally or alternatively be configured for hardwired network communication with an environment monitoring device 113, which in turn can comprise one or more sensors 107. In one example, the one or more sensors 107 are located on or within the dispensing apparatus 110, which, in turn, may also be located in, or sufficiently proximate to, the coating application area 160. Furthermore, one will appreciate that the illustrated one or more sensors 107 can comprise a number of different sensors for monitoring the physical environment of coating application area 160, such as a humidity sensor, a temperature sensor, a barometric pressure sensor, or the like. Furthermore, the environment monitoring device 113 can be configured as a standalone unit for use in coating application area 160, or can be configured as an attachment of a spray applicator 150, or otherwise included with one or more other computing elements used in the coating application area 160. In still further aspects, the dispensing apparatus 110 may be located in a completely separate geographical location relative to the coating application area 160.

In the coating application area 160, a spray applicator 150 (e.g., whether robotic, or operated by a human user) can apply, or mix and apply, a given set of coating reagents to a given object, such as the illustrated vehicle 140. One will appreciate that the illustrated vehicle 140 is but one type of object that may be coated or painted in the coating application area 160. A coating applicator may, for example, spray other types of objects, or parts thereof, as needed, including body panels, original parts, replacement parts, and the like. Other objects may include boats, bicycles, industrial, commercial, or other residential equipment, doors, walls, and parts or portions thereof. Accordingly, both the terms object and vehicle will be understood to be broadly encompassing of any physical object to be coated.

FIG. 1 also illustrates a schematic of a computing system 170 that can be used in connection with the system 100. The computing system 170 can be a stand-alone computing system operated by, for example, a remote user, or may be embodied within the dispensing apparatus 110 itself, or may comprise a set of various client and server systems that are in communication with one or more of the dispensing apparatus 110 and/or coating applicator 150. In addition, the illustrated computing system 170 can comprise any number of software components, and modules, as well as physical memory, physical storage, or even virtual or network-based versions of the same, as needed to effectuate the steps and mechanisms outlined herein. For example, FIG. 1 shows that computing system 170 comprises a network interface component 163 that receives and delivers communications over network 105.

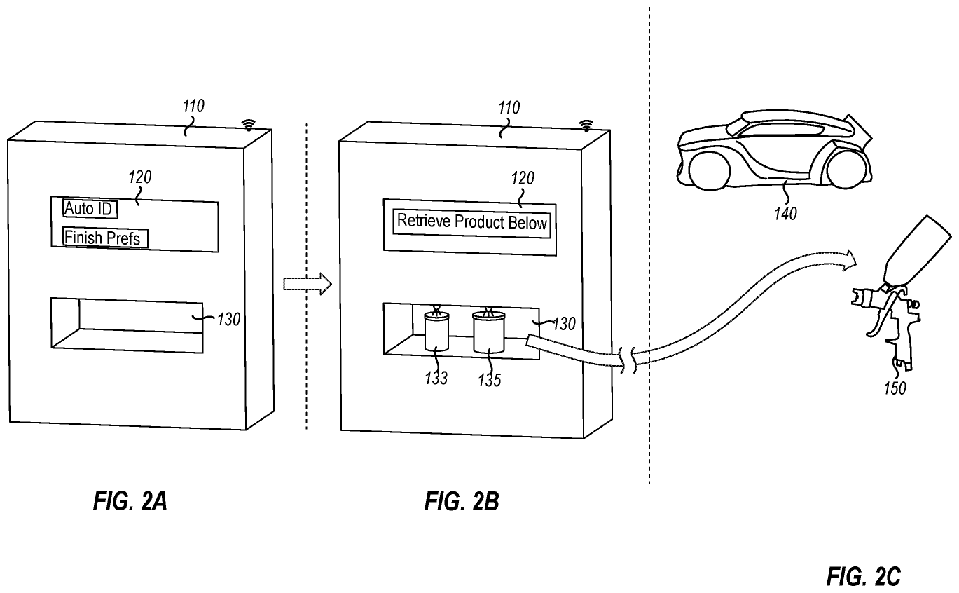

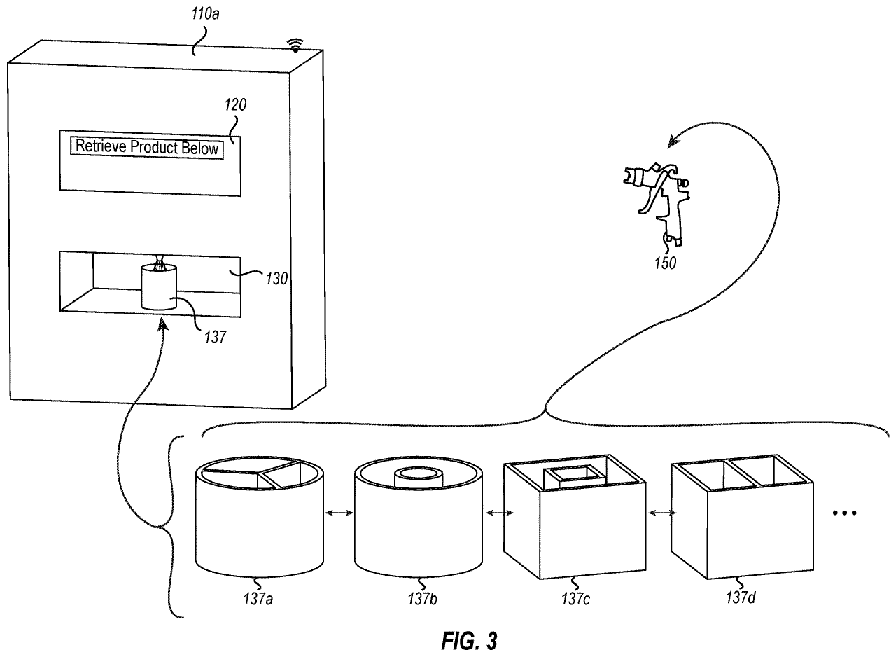

FIG. 1 also shows that computing system 170 can comprise a database 180, having stored thereon a set of various components that comprise various data and logic for managing component amounts and mix ratios as compared with environmental data, as well as various end-user preferences and object/vehicle data. For example, FIG. 1 shows that database 180 comprises a mix ratio component 185a, an environmental data component 185b, an inventory component 185c, a vehicle data component 185d, and a user preferences component 185e. The components of FIG. 1 are referenced below in the discussion relevant to FIGS. 2A-3.

For example, FIGS. 2A, 2B, and 2C illustrate a sequential schematic of the dispensing apparatus 110 in operation. In particular, FIG. 2A shows that dispensing apparatus 110 can provide a user interface 120 through which an end-user enters various preferences and other inputs about the object. As previously mentioned, the user may enter this information directly in a user interface 120 presented by the dispensing apparatus 110, or as may be supplied via one or more separate, stand-alone computing systems, such as a mobile device, or desktop computer system working in connection with dispensing apparatus 110. Thus, the display shown on dispensing apparatus 110 is merely for way of illustrative convenience.

FIG. 2A further shows that, through user interface 120, a user can select and provide data about the object to be coated, such as Auto ID, vehicle identification information (VIN), make/model/year of an object, or the like. For example, the user may interact with a user interface 120 on dispensing apparatus 110, or may interact with user interface 120 displayed through a mobile phone, or desktop computer, and select the Auto ID button (or other object identification information). The user can then enter object data, which in turn may display various color or clearcoat options that the user can then select through interface 120. Even though FIG. 1 shows a separate sensor 107 communicating environmental data 115b, the user may also manually enter this information so that the dispensing apparatus 110 may receive the environmental data from either the end-user, the sensor 107, or some mixture thereof. For example, the user may simply read the sensor or other instrumentation from device 113, and or the user may gather other known environmental information for the coating application area 160 from public data, and enter it through a user interface. In other cases the dispensing apparatus 110 may receive some environmental data directly from the one or more sensors 107, while other environmental data is provided as input from the end-user through user interface 120.

In any event, some of the user preferences entered through interface 120 may include, for example, various physical attributes of a coating when applied, or finishing speed preferences. The preferences can be entered and processed as one or more messages 115a by computing system 170, and stored in the user preference component 185e of database 180. By way of explanation, FIG. 1 shows merely for purposes of illustration that the one or more messages 115a supplying user data are in transit from the dispensing apparatus 110 to computing system 170. One will appreciate, however, that this schematic is merely for convenience to show interaction between the user and computing system 170, which in turn may or may not be included within dispensing apparatus 110 or may be supplied through another one or more separate devices.

In any event, the finishing preferences 115a can include desired physical characteristics in the finished product, such as texture or color, or other visible effects in the case of general coatings, or smoothness, shine, or gloss, and so forth in the case of clearcoat. The user may be able to provide other preferences sent with the messages 115a, such as preferences to have certain curing or hardening speeds, speeds of application, and/or to avoid certain compounds among other available reagent options. For example, an end user may desire certain preferences for gloss or smoothness, or application speed, but would like to avoid the use of certain types of volatile compounds, or other reagent compounds for which a local environment may be more sensitive.

FIG. 1 also shows that, in addition to the user supplied data in the one or more messages 115a, the computing system 170 can also process various environmental input via various messages 115b. The various environmental inputs 115b can be entered by the user, or taken from the local environment sensors 107, which may provide various localized data for the coating application area 160. As mentioned, the one or more messages 115b can comprise data corresponding to humidity, temperature, pressure, or other local environmental variables for the coating application area 160. The computing system 170 can compare the requests or other informational downloads from messages 115a, 115b directed to the desired result or finish, and then determine an appropriate set of coating reagents that are optimized for or otherwise dictated by the user-or sensor-supplied data. For example, determining module 175 may determine that the entered automotive information and finish information provided by the user in the one or more messages 115a involves a particular set of polymer reagents at a particular volume, as well as crosslinking reagents, and/or catalyzing reagents at a different volume and mix ratio. Each of these can take the form of one or more reagents dispensed into a user-specified volume (i.e., customized volume).

For example, dispensing apparatus 110 can be configured for active management of inventory, and thus may comprise several physical compartments (not shown), which are barcode-(or other machine-readable indicium)-restricted, meaning that a barcode (or other relevant machine readable indicum) scan may be needed for a particular reagent compartment of a particular size in order for the compartment door to open. Along these lines, there may be two physical locations for polymer reagent within (or otherwise accessed by) dispensing apparatus 110, such as a location/compartment for 1 oz containers on up to 1 liter-size containers, multi-liter containers, and different locations/compartments for volumes in-between. Similarly, there may be physically-sized slots that limit what particular containers of certain sizes or diameters may be inserted in the slots. The dispensing apparatus 110 may, in turn, only unlock the relevant compartment or slot for the container and particular ingredient upon confirmation of the barcode or other machine indicia found on the given container (e.g., 133, 135). Thus, although not shown, dispensing apparatus 110 may comprise various machine-code readers, such as a barcode reader, a QR code reader, an infrared reader, or other form of wireless or Bluetooth protocol that computer system 170 can use to verify and/or process a given. The machine readers and machine-readable indicia can enable rapid and precise inventory management.

One will of course appreciate, however, that having such a restriction to inventory placement is not necessarily required. For example, the dispensing apparatus 110 may not have any sort of machine-reading requirement, but may instead have a user interface (or generic physical lock and key mechanism) that a user merely needs to enter or unlock in order to unlock a given storage compartment. In still further cases, the dispensing apparatus 110 may be configured for more passive management, meaning that the end-user may have such a locking mechanism disabled, or the dispensing apparatus 110 may generally allow a user to freely add or remove containers at will, such that the user primarily manages the inventory directly through user interface 120. Hence, the inventory component 185c of database 180 may be alternatively configured for active management and/or passive management. That is, active management involves a machine verification system for accessing a storage compartment, while the passive management avoids such requirements, or otherwise places the inventory management in the hands of user input, or other forms of separate user management.

In either case, dispensing apparatus 110 can be configured to store different volumes and mixtures of polymer reagents, along with any additives within various preset volumes, such as a few ounces up to multiple liters, as previously mentioned. For example, a polymer reagent storage compartment may comprise in separate physical size or volume compartments certain containers having various unique resins, along with the aforementioned ultra-violet absorbers (UVA)/Hindered Amine Light Stabilizers (HALs) additives and solvents mixed with particular viscosities in predefined volumes in order to best manage inventory based on rates of denaturing of the polymer solutions. The polymer compartment may include areas for storing a wide range of resins with differing polymer properties, including differing storage for polymers differing by Mw, Tg, functionality and reactivity, or to be mixed at other viscosities.

In addition, dispensing apparatus 110 can be configured to store different sizes and mixtures of crosslinker reagents at certain preset volumes, such as in the case of coatings in the form of clearcoats. For example, dispensing apparatus 110 may contain various physical compartments (not shown) for storing crosslinker reagents with differing crosslinkers and solvents within various preset volumes, such as few ounces to several liters, as applicable. The crosslinker storage compartments can contain physical containers having several different, unique crosslinkers that cover wide ranges of crosslinker properties, also including Mw, Tg, functionality and reactivity. Dispensing apparatus (e.g., 110, FIG. 1) can then retrieve and dispense from an appropriate crosslinker physical container of an appropriate volume upon selection, or upon designation by computer system 170 if appropriate for the user-selected coating and end result properties. Moreover, dispensing apparatus 110 may be particularly sealed connections to crosslinker reagents (or other sensitive reagents) so that the dispensing apparatus can carefully withdraw crosslinker from the container and dispense it without ruining the remainder within the storage container, and allowing the remainder to be used at a future time.

Still further, dispensing apparatus 110 may comprise different physical compartments (not shown) for storing different sizes and mixtures of catalyst reagents, which may also employ sealed connections, such as in the case of the above-mentioned crosslinker reagents. In particular, dispensing apparatus 110 may contain various physical compartments (not shown) for storing catalyst reagents with differing modulators, inhibitors and solvents, and in given physical containers at various preset volumes, such as a few ounces to multiple liters, as applicable. The concentration of catalyst in the reagents may range from 1% to 100%, and may be stored in different physical locations in order to enable precise retrieval and delivery by the dispensing apparatus 110 of the given mixtures. Along similar lines, the dispensing apparatus 110 can also store a number of reducer reagents in various preset volumes, and in specifically designated physical compartments as similarly noted above. As previously mentioned, each reducer reagent may comprise one or more solvents with a specific range of physical properties, such as relative evaporation rate, and Hansen solubility parameters. The computing system 170 can optimize the particular delivery of different physical containers to best match the user preferences and environmental information.

Along these lines, FIGS. 2A, 2B, and 2C illustrate a sequential schematic in which the dispensing machine in FIG. 1 distributes physical reagent containers for use in a coating application, in accordance with the present disclosure. In particular FIG. 2A shows that an end user enters various indicium via a user interface 120. As previously noted, the user interface 120 may comprise rendered instructions on a display provided by dispensing apparatus 110, or alternatively may comprise a rendered interface on another, separate computer system. Through the user interface 120, the end-user enters the information pertaining to the object to be coated, such as an object or automotive ID. This may be in the form of a vehicle identification number (VIN), a make/model/year of a given vehicle, or other form of information that enables the computing system 170 to identify an amount and/or type of coating material to be used. The user may also enter in other information that indicates an amount of the object to be coated, if less than all of the vehicle. Through the user interface 120, the user may also enter various preferences for the coating, such as gloss, smoothness, shine, texture, application or curing speed, or types of component reagents to use or to be avoided as applicable.

As previously mentioned for FIG. 1, the computer system 170 can take the information entered by the user via one or more messages 115a, and compares the requests with the given environmental data 115b to thereby ensure that the recommended reagents are optimized for the environment. In other cases, the computing system 170 may additionally or alternatively include public weather information that may indicate future data for temperature, pressure, and humidity, and consider such information along with current local data in the coating application area 160. Hence, the computing system 170 can consider immediate time frames, as well as eventual time frames. This may enable the computing system 170 to be used to prepare containers at a remote location that can be delivered for use within a given time frame in the coating application area 160. Such an arrangement may be particularly helpful for smaller shops that may have difficulties storing excess inventory.

FIG. 2B shows that, upon review and calculation of the various inputs by the computing system 170, the dispensing apparatus 110 provides a corresponding set of reagents into containers, such as the illustrated physical containers 133, 135. One will appreciate that the physical containers 133, 135 will contain customized, dispensed volumes of reagent, such as a custom volume polymer and a custom volume of crosslinker, or a polymer mixture, crosslinker mixture, and/or a catalyst mixture, or other relevant combinations (not shown) that are customized to the user-entered data (e.g., from FIG. 2A) in appropriately configured dosing ratios. Because the dispensing apparatus 110 can dispense the precise amounts requested by the user, or optimized for the entered parameters, the dispensing apparatus helps avoid waste to the extent possible. The computing system 170 can likewise retrieve multiple volumes of reagent in various mixtures of container sizes for larger jobs, and dispense all or fractions thereof to the user as applicable. Hence, the two illustrate physical containers 133, 135 in FIG. 2B are only by way of example, and there may be many more physical containers with different sizes provided as applicable into which the dispensing apparatus 110 will dispense reagent. Still further, the dispensing machine can provide mixing instructions through the user interface 120, or through a printed object provided in the dispensing location 130. For example, the computing system 170 can determine and provide specific recipe, mix, and cleanup instructions for each reagent provided, and/or for the combination of reagents added together. This could be shown on user interface 120, or printed on a label that is attached to the cup into which the apparatus 110 dispenses the reagent.

FIG. 2C further shows that the end user can then take the dispensed reagents and supply the reagents directly to the coating applicator 150. For example, the coating applicator 150 can comprise an e-coat apparatus, a coating atomizer, a spray gun, or other form of coating application device. The physical containers 133, 135, etc., in turn, can be configured for direct application to the coating applicator 150. For example, the physical containers 133, 135 may comprise a particular physical connection interface (e.g., lid, or other interface within an upper removable lid), that interfaces physically and directly with a corresponding physical interface of the coating applicator 150. The precise physical interconnection may be employed in a number of different ways between the coating applicator 150 and the physical containers 133, 135. In one example, the physical containers 133, 135 have a particularly-shaped lid that direction connects to a receptable in coating applicator 150, which causes a release of reagent.

This may be by perforation of a membrane or bladder, or, for example, where insertion of the container 133, 135 causes a physical retraction of a sealing element, thereby allowing reagent to flow therein. In still other cases, the user may manually release a lid of the physical container 133, 135, and simply pour the particular reagent contents directly into the coating applicator 150. Similarly, the user may open and manually mix the containers in accordance with the provided mix instructions, and then provide the already mixed materials into the coating applicator 150.

FIG. 3 illustrates various alternate containers (e.g., 137a, 137b, 137c, 137d) that can be used in different formats for receiving the dispensed reagents. By way of explanation, dispensing apparatus 110 can deliver reagents in either ready-to-use mixtures or ready-to-mix containers even in a single container. In other cases, dispensing apparatus 110 can deliver reagents into multiple containers (e.g., FIGS. 2A-2B) of single or multiple containers or compartments. In still other cases, dispensing apparatus 110 can deliver reagents into multiple containers or compartments all within the same container. For example, FIG. 3 shows some example, alternate container formats 137a-137b, which include by way merely of example circular or cylindrical formats 137a-b with internal compartment divisions, while containers 137c-137d show square or rectangular containers with internal compartment divisions.

Thus, while container 137 in FIG. 3 shows a single container with no extra compartments, the compartment divisions in the alternate containers 137a-137d (or containers within containers) can be used to separate reactive components or other types of reagents that may more quickly denature upon mixing. In other cases, the given containers (whether single or multiple compartment containers) may contain a sealable bladder for one of the compartments, while the others remain open to air. In still other cases, the containers may include lids that are specifically shaped to preserve and seal containers or compartments within the containers 137a-137d. One will appreciate that other shapes and compartment configurations may be used in accordance with the present disclosure.

In addition to the foregoing, the dispensing apparatus 110 may itself also be specifically configured with variously aligned dosing nozzles to achieve the different delivery of reagents simultaneously or sequentially, as needed. For example, the dispensing apparatus 110 may be configured to deliver both a polymer reagent and a crosslinking reagent at the same time into two separate compartments of any of containers 137a-137d. In particular, one set of one or more nozzles may be connected to a crosslinker or catalyst feed line, while another set of one or more nozzles may be connected to a polymer or other reagent feed line. The dispensing apparatus 110 can deliver both at alternate times to avoid mixing, or at the same time through different nozzles into an appropriate compartment of the given container. The user can then seal the container 137 (or 137a-d) with an air-tight lid, and subsequently mix the reagents when ready to apply.

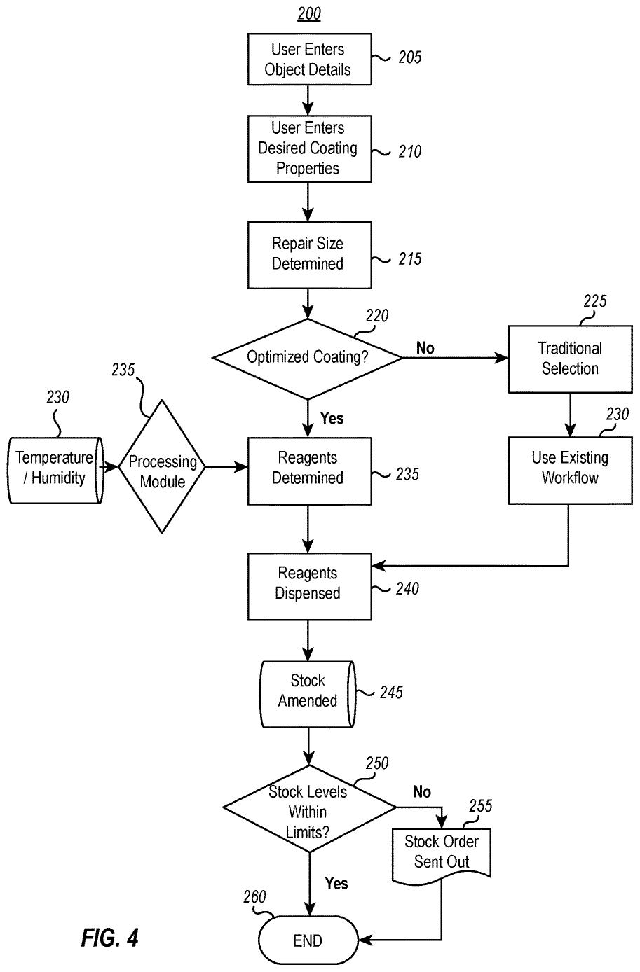

FIG. 4 illustrates an example flowchart 200 of a decision tree for use in dispensing one or more applicable coating reagents for use in accordance with the present disclosure. For example, FIG. 4 shows that a decision tree can begin with an act 205, in which a user enters object details. For example, as shown in FIGS. 1 and 2A, the end-user can enter in various object details, such as vehicle identification number, make, model, year, color, and so forth. Moreover, the object is not limited to automobiles, but can represent other types of objects, including but not limited to aerospace, recreational vehicles (e.g., boats), or other consumer objects (e.g., bicycles) for which a coating is needed.

FIG. 4 further illustrates in a next act 210 that the user can enter desired coating properties. For example, as shown in FIGS. 1 and 2A, the user can enter data through a user interface 120 that indicates preferred finishes or other physical properties of the final look and feel of the coating. For example, in a clearcoat environment, the end user may specify gloss, smoothness, smoothness, texture, or other types of variables for achieving a particular look and feel. This can have implications to the type of crosslinker or other catalysts, inhibitors, solvents, reducers, and so forth that may be needed in the mixture to attain particular viscosities for particular applications, or to achieve a final end appearance.

Along these lines, FIG. 4 shows that a next step in the decision tree 200 can include an act 215 of calculating the repair size. For example, computing system 170 (FIG. 1) can take the user inputs 115a, which may include an option to either use user specifications, or to use the computer-generated reagents. If the user selects its own reagents without optimization, the decision tree flow to acts 225 and 230, in which the dispensing apparatus 110 identifies and dispenses the requested reagents into a given container (e.g., 133, 135, 137, FIGS. 2A-3). If the user selects an optimization, such as “optimized coating,” the computing system 170 may then optimize the user inputs in connection with user recommendations and environmental variables.

For example, FIG. 4 shows that, in view of the selected optimization, the computing system 170 can also take into account local environmental variables. As previously noted, this may be accomplished by computing system 170 receiving and processing one or more messages 115b from one or more sensors 170, and/or similar data directly from the end-user. The one or more sensors 107 can be included or attached to the coating applicator 150, and/or may be located in one or more separate standalone devices, such as may the illustrate environment monitoring device 113. The computing system 170 can then coordinate with various rules/components in database 180 to determine an optimum volume and type of reagents.

Accordingly, FIG. 4 shows that the decision tree can further include an act 235 of determining a particular set of reagents. For example, for a job that needs 2.0 liters of polymer reagent, and 0.5 liters of crosslinker and/or catalyst, the computing system 170 may dispense the same into relevant separate containers (or multiple containers/compartments within a container), and print or display relevant mixing instructions. The computing system 170 may adjust these requirements upward or downward based on current environmental variables, and/or anticipated environmental variables based on other public data about regional temperature, pressure, and humidity. For example, in alternative environments, even one mixture of polymer reagent might normally be specified in a standard environmental condition (e.g., ambient temperature, pressure, etc.), the computing system 170 might determine that an alternate ratio of polymer reagent instead might be needed to complete the job in correlation with non-standard environmental conditions (e.g., higher temperature, pressure, or humidity). This may result in an substitution of a type of reagent, or even a reduction or increase of otherwise expected amount of given reagents within the volume, or other mix ratio parameters. One will also appreciate that the number or amount of reagents within the volume can be optimized based on given inventory. For example, the computing system 170 may base the number of reagents to dispense based on the number of reagents held in a given storage compartment. Alternatively, the computing system 170 may prepare a list of physical reagents of given sizes based on expected future inventory, such as based on expected shipments of particular reagents.

FIG. 4 further shows that the decision tree can then move to steps 240 and 245, in which the dispensing apparatus 110 dispenses the reagents determined by the computing system 170. The dispensing apparatus 110 (and/or computer system 170) can then send one or more messages to an inventory component 185c of database 180, indicating which reagents have been retrieved (act 245) and need to be restocked (e.g., at decision 250). Thus, the inventory is automatically added and deleted by the dispensing apparatus 110/computing system 170 with each receipt and storage of reagents as well as with each delivery. In particular, as inventory is close to depletion, the decision tree in FIG. 4 further moves to acts 250 and 255. In act 250, the computing system 170 coordinates with the aforementioned inventory component 185c to determine what remains in storage in the dispensing apparatus 110, what components are in excess or close to depletion, and hence what needs to be reordered. The dispensing system can automatically send out a restocking request in act 255 to a warehouse system, or display an alert to the user prompting the same. FIG. 4 shows that the decision tree completes at this point, i.e., step 260.

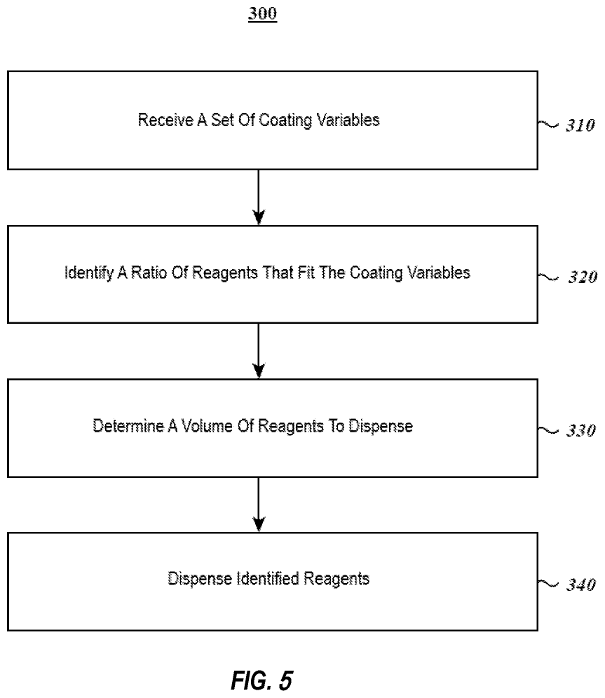

The present disclosure can also be described in terms of methods comprising a series of acts for accomplishing a particular result. For example, FIG. 5 provides a flowchart of a method of dispensing coating reagent to an end-user through a dispenser apparatus. The acts of FIG. 5 are discussed below in the context of the components, modules and diagrams of FIGS. 1-3.

FIG. 5 illustrates that an additional or alternative method 300 for use in determining and delivering one or more applicable coating reagent containers can comprise an act 310 of receiving a set of coating variables. Act 310 includes receiving a set of coating variables comprising: (i) data corresponding environmental input corresponding to local environmental data located adjacent a coating application area, and (ii) one or more end-user supplied application variables for applying the coating to an object. For example, an end-user provides various details about an object to be coated, as well as variables relevant to final look and appearance, through a user interface 120. The user interface 120 may be presented directly at the dispensing apparatus 110, or may be presented through a mobile or other standalone computing device serving as computing system 170, upon which the relevant data are sent to the dispensing apparatus 110.

FIG. 5 also illustrates that method 300 can comprise an act 320 of identifying a ratio of reagents to use. Act 320 includes based upon the received coating variables, identifying (i) a subset of reagents, including at least a polymer reagent for applying a coating to an object, (ii) one or more additional reagents, (iii) a dosing ratio for each identified reagent in the subset. For example, computing system 170, in connection with dispensing apparatus 110, can use the user supplied variables 115a and potentially also one or more environmental variables in message 115b to determine an amount of different types of reagents to complete the task. The determination includes an appropriate ratio (or dosing ratio) for the end mixture to be applied for each reagent, or each type of reagent determined.

In addition, FIG. 5 shows that method 300 can comprise an act 330 of determining a volume of reagents to dispense. Act 330 includes determining a volume of the subset of reagents to dispense, wherein the volume depends on the received environmental data for the paint application area, and the one or more end-user supplied application variables. For example, in addition to determining the ratios from act 320, computing system 170 can also determine a various volumes of reagents to dispense, which may be based on various object properties (size, make model, type of application), or variously desired physical attributes of the applied coating.

Furthermore, FIG. 5 shows that method 300 can comprise an act 340 of dispensing the identified reagents. Act 340 includes, upon receipt of user confirmation through the dispenser apparatus, dispensing an effective amount of each identified reagent of the subset and in the determined volume. For example, FIGS. 2B and 2C shows that dispensing machine delivers the determined reagents into physical containers 133, 135 or 137(a-d), and can further provide relevant mixing or other end-use instructions.

Such instructions can further include various MSDS (material safety data sheet) information needed to properly work with the given reagents. Such instructions can still further include computer-oriented instructions to execution by a separate computing device, such as a mobile device, tablet, watch, or personal computer that provides various timing alerts regarding expiration of given reagents or mixtures from the point of delivery, or from other variables measured from an application start/stop top received from the coating applicator 150. The computing system 170 can determine a sequence of steps for adding the reagents, when to add them and in what amounts into a coating applicator 150. The computing system 170 can also determine and provide instructions relevant to the shelf life of the given reagents upon mixture with another reagent, and/or upon exposure to a reactive environment that begins to degrade the reagent. For example, the computing system 170 may provide instructions that a mixture of polymer reagent and crosslinking reagent has approximately two hours to be applied before the mixture needs to be discarded due to degradation, or otherwise due to other curing or setting the prohibits wet application.

Additional aspects of the present disclosure include one or more novel compositions that the dispensing apparatus 110 can provide. For example, a coating composition mixed or otherwise dispensed by the dispensing apparatus 110 can include a volume in a determined amount, the volume having a plurality of reagents. In one example, the plurality of reagents dispensed can include: one or more types of polymer reagent to use, and an effective amount thereof. As used herein, an “effective amount” means an amount or ratio of reagent that either by itself or in combination with one or more other determined reagents accomplishes a desired result in the end mixture when applied to an object. For example, an effective amount of polymer and/or effective amount of crosslinker may vary depending on environmental variables and in connection with user preferences for smoothness, or gloss, as described herein.

For example, the volume to be dispensed can further include a determined (e.g., by computer system 170 in response to environmental input and user preferences) one or more types of crosslinker reagent to use, and an effective amount thereof. As noted before, the volume amount and effective amounts of each of the plurality of reagents is determined by computing system 170 from the end-user supplied coating application variables (message 115a), and the environmental data (message 115b) in the form of temperature, pressure, and humidity data received from one or more environmental sensors. In additional or alternative configurations, the composition can also include one or more types of catalyst reagent to use, and an effective amount thereof, as well as one or more types of reducer reagent to use, and an effective thereof. Again, these amounts may be determined by computing system 170 from a wide variety of options, or otherwise optimize from specific user entries. For example, a user may desires a particular brand or type of crosslinking reagent or catalyst, which may cause the computing system 170 to adjust the use or amount of the polymer reagents (or types thereof) or amount/type of other additional reagents.

In still further examples, the one or more types of polymer reagent can also include a plurality of additives where the one or more types of polymer reagents and the plurality of additives mixed in a polymeric reagent solution. The polymers and reagents can be adjusted for examples in which the coating is a clearcoat, or whether the coating is meant as a multilayer coating a monocoat, a top coat, a base coat, a primer, or an adhesion layer, or other forms of coatings. Thus, depending on the type and volume of the resulting coating mixture, the computing system 170 may also determine the addition of one or more additives including any one or more of (i) an ultra-violet light absorber, and (ii) a hindered-amine light stabilizer. The coating composition as recited can further be adjusted with respect to the polymeric reagent solution for a desired viscosity to be dispensed.

As previously noted, the coating composition can include a crosslinker reagent, where the crosslinker comprises a solution that includes the effective amount of crosslinker and one or more solvents. The crosslinker reagent solution may similarly be adjusted by the for a desired viscosity to be dispensed. Further along these lines, the composition can include a catalyst reagent, which includes a solution having effective amounts of catalyst and one or more solvents. The catalyst reagent solution can include any one or more of: (iii) a catalyst modulator; or (iv) a catalyst inhibitor; and the effective amount of each catalyst reagent depends on the environmental sensor data and user-defined coating application variables. Still further, the composition dispensed through apparatus 110 can include a reducer reagent that has a solution that includes a plurality of solvents where the plurality of solvents differ by evaporation rate. As such, one will appreciate that the composition to be mixed and dispensed in a wide number of ways through use of a select, relatively small number of reagents maintained in inventory.

Accordingly, the present disclosure provides a number of systems, components, compositions, and methods that enable a number of advantages over the present art. For example, when customers need to repair and paint cars, the proper ready-to-use or ready-to-mix product is provided to them on-demand. This can allow coating applicators to focus on spraying paint or other coating formulations without an accompanying need to make precise selections and mix them in a precise ratio. This simplifies the work process for end-users and addresses several conventional difficulties. Because a coating manufacturer providing the solutions outlined herein are providing not only paint, but also services that are beneficial to end-users, coating manufacturers can expand the way they connect with end-users. The connection can be facilitated by delivering ready-to-use products that best fit the end-user's needs on-demand. That is, both large and small shops can order reagents on demand, and apply them precisely as needed in a timely fashion without error.

The following discussion is intended to provide a brief, general description of a suitable computing environment in which the present disclosure may be implemented. Although not required, the present disclosure will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the present disclosure may be practiced in network computing environments with many types of computer system configurations, including personal computers, hand-held devices, multi-processor systems, microprocessor-based or programmable consumer electronics, network PCs, minicomputers, mainframe computers, and the like. The present disclosure may also be practiced in distributed computing environments where local and remote processing devices perform tasks and are linked (either by hardwired links, wireless links, or by a combination of hardwired or wireless links) through a communications network. In a distributed computing environment, program modules may be located in both local and remote memory storage devices.

The present disclosure may comprise or utilize a special-purpose or general-purpose computer system that includes computer hardware, such as, for example, a processor and system memory, as discussed in greater detail below. The scope of the present disclosure also includes physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, the present disclosure can comprise two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the present disclosure.

Transmission media can include a network and/or data links which can be used to carry program code in the form of computer-executable instructions or data structures, and which can be accessed by a general-purpose or special-purpose computer system. A “network” is defined as data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module, and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general-purpose computer system, special-purpose computer system, or special-purpose processing device to perform a certain function or group of functions. Computer-executable instructions may be, for example, binaries, reagent format instructions such as assembly language, or even source code.

Those skilled in the art will appreciate that the present disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The present disclosure may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the present disclosure may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

A cloud-computing environment, or cloud-computing platform, may comprise a system that includes a host that is capable of running virtual machines. During operation, virtual machines emulate an operational computing system, supporting an operating system and perhaps other applications as well. Each host may include a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine interfaces with the appearance (e.g., a virtual resource) of a physical resource. Examples of physical resources including processing capacity, memory, disk space, network bandwidth, media drives, and so forth.

Aspects of the present disclosure can be described in terms of various different configurations and alternates thereof. For example, in a first aspect, a computer-implemented method for dispensing coating reagent to an end-user through a dispenser apparatus, includes: receiving, by a computing system, a set of coating variables, which can include: (i) data corresponding environmental input corresponding to local environmental data located adjacent a coating application area, and (ii) one or more end-user supplied application variables for applying the coating to an object; based upon the received coating variables, identifying, by the computing system, (i) a subset of reagents, including at least a polymer reagent for applying a coating to an object, (ii) one or more additional reagents, (iii) a dosing ratio for each identified reagent in the subset; identifying, by the computing system, based upon the received one or more coating variables, a first ratio of polymer reagent to use in the subset of reagents; determining, by the computing system, a volume of the subset of reagents to dispense, wherein the volume depends on the received environmental data for the paint application area, and the one or more end-user supplied application variables; upon receipt of user confirmation, dispensing through the dispenser apparatus, an effective amount of each identified reagent of the subset and in the determined volume.

In a second aspect, the computer-implemented method as recited in any of the first aspect can further include identifying, by the computing system, a second ratio of crosslinking reagent as part of the one or more additional reagents. In a third aspect, the computer-implemented method as recited in any of the first through second aspects can further include: determining, by the computing system, a plurality of types of the crosslinking reagent to be used; and determining, by the computing system, a plurality of types of the polymer reagent to be used. In a fourth aspect, the computer-implemented method as recited in any one of the first through third aspects can further include receiving the environmental data from one or more environmental sensors connected over a network. In a fifth aspect, in the computer-implemented method as recited any one of the first through fourth aspects, the one or more environmental sensors are positioned remote of the dispenser apparatus. In a sixth aspect, the computer-implemented method as recited in any one of the first through fifth aspects, can further include identifying, by the computing system, the following additional reagents: a third ratio of catalyst reagent; and a fourth ratio of reducer reagent; wherein each of the first, second, third, and fourth ratios are determined from the received one or more coating variables.

In a seventh aspect, in the computer-implemented method as recited in any of the first through sixth aspects, the reducer reagent has an evaporation rate characterized as slow, medium, or high. In an eighth aspects, in the computer-implemented method as recited in any one of the first through seventh aspects, the object comprises a vehicle. In a ninth aspect, in the computer-implemented method as recited in any one of the first through eighth aspects, the coating application variable received from the end-user defines a make and model of the vehicle. In a tenth aspect, in the computer-implemented method as recited in any of any the first through ninth aspects, the end-user supplied application variables include a desired physical property of the coating once applied to the object. In an eleventh aspect, in the computer-implemented method as recited in any of the first through tenth aspects, the desired physical property comprises any one or more of (i) smoothness, (ii) glossiness, (iii) texture, and/or (iv) film build. In a twelfth aspect, in the computer-implemented method as recited in any of the first through eleventh aspects, the desired physical property comprises any one or more of (i) polish-ability, (ii) sand-ability, and (iii) substrate type; and the substrate type comprises plastic, and/or metal. In a thirteenth aspect, in the computer-implemented method as recited in any one of the first through twelfth aspects, the desired property comprises: (i) speed of application of the coating or speed of cure of the coating on the object; and (ii) whether the coating will be air dried or baked.

In a fourteenth aspect, in the computer-implemented method as recited in any one of the first through thirteenth aspects, the desired property comprises size, or object size. In a fifteenth aspect, in the computer-implemented method as recited in any one of the first through fourteenth aspects, the desired property designates the coating as a single layer or multi-layer coating. In a sixteenth aspect, in the computer-implemented method as recited in any one of the first through fifteenth aspects, the desired property comprises a desired volume of coating mixture. In a seventeenth aspect, in the computer-implemented method as recited in any of the preceding first through sixteenth aspects, the environmental data correspond comprise at least one of the following variables for the paint application area: (i) temperature, (ii) humidity, and (iii) atmospheric pressure. In an eighteenth aspect, in the computer-implemented method as recited in any of the second aspect, or any preceding aspect depending thereon can further include: dispensing the subset of reagents as a mixture corresponding to the identified first ratio and second ratio; and displaying a time limit during which the subset of reagents are to be applied to the object when mixed.

In a nineteenth aspect, in the computer-implemented method as recited in any of second aspect, or any preceding aspect depending thereon can further include: based on the environmental input, dispensing the subset of reagents according to the first ratio and the second ratio into one or more physical containers in which the crosslinking reagent and polymer reagent are unmixed, and are physically separated from reaction with one another. In a twentieth aspect, in the computer-implemented method as recited in any of the preceding first through nineteenth aspects can further include: receiving the end-user supplied coating variables over the internet from a geographically remote location.

In addition to the foregoing, twenty-first aspect of the disclosure includes a coating composition made using the computer-implemented method recited in any of the first through twentieth aspects. In a twenty-second aspect, the coating composition as recited in any of the twenty first aspect can further include a volume in an amount, the volume having a plurality of reagents, wherein the plurality of reagents include: (i) one or more types of polymer reagent to use, and an effective amount thereof; (ii) one or more types of crosslinker reagent to use, and an effective amount thereof; and wherein, the volume amount and effective amounts of each of the plurality of reagents is determined from: the end-user supplied coating application variables; and the environmental data in the form of temperature, pressure, and humidity data received from one or more environmental sensors. In a twenty-third aspect, the coating composition are recited in any of the twenty-first through twenty-second aspects can further include at least one of: (iii) one or more types of catalyst reagent to use, and an effective amount thereof, and (iv) one or more types of reducer reagent to use, and an effective thereof. In a twenty-fourth aspect, in the coating composition as recited in any of the twenty-second through twenty-third aspects, the one or more types of polymer reagent further comprise a plurality of additives; the one or more types of polymer reagents and the plurality of additives mixed in a polymeric reagent solution.

In a twenty-fifth aspect, in the coating composition as recited in any of the twenty first through twenty-fourth aspects, the polymer reagent comprises a clearcoat; and the polymer reagent further comprises one or more additives including any one or more of (i) an ultra-violet light absorber, and (ii) a hindered-amine light stabilizer. In a twenty-sixth aspect, in the coating composition as recited in any of the twenty-fifth aspect, the polymeric reagent solution is adjusted for a desired viscosity to be dispensed. In a twenty-seventh aspect, in the coating composition as recited in any of the twenty-second through twenty-sixth aspects, the crosslinker reagent comprises a solution that includes the effective amount of crosslinker and one or more solvents. In a twenty-eighth aspect, in the coating composition as recited in any of the twenty-first through twenty-seventh aspects, the crosslinker reagent solution is adjusted for a desired viscosity to be dispensed. In a twenty-ninth aspect, in the coating composition as recited in any of the twenty-first through twenty-eighth aspects, the catalyst reagent can include a solution that includes the effective amount of catalyst and one or more solvents.

In a thirtieth aspect, in the coating composition as recited in any of the twenty-first through twenty-ninth aspects, the catalyst reagent solution can further include any one or more of: (iii) a catalyst modulator; or (iv) a catalyst inhibitor; and the effective amount of each catalyst reagent depends on the environmental sensor data and user-defined coating application variables. In a thirty-first aspect, in the coating composition of any of the twenty-third aspect, or any of the twenty-first through thirtieth aspects, the reducer reagent comprises a solution that includes a plurality of solvents; and the plurality of solvents differ by evaporation rate.

In addition to the foregoing, a thirty-second aspect of the present disclosure can include a dispensing machine configured to provide ready to use packages of coating reagents in a customized amount, comprising: a processor; a plurality of containers for various reagents comprising a container of at least polymer reagents, and one or more additional reagents, wherein each container of the plurality is physically sealed from interaction with each other; and a computer-readable storage medium comprising computer-executable instructions stored that, when executed, cause the processor of the dispensing machine to perform the following: receive a set of coating variables comprising: (i) data corresponding environmental input corresponding to local environmental data located adjacent a coating application area, and (ii) one or more end-user supplied application variables for applying the coating to an object; based upon the received coating variables, identify (i) a subset of reagents, including at least a polymer reagent for applying a coating to an object, (ii) one or more additional reagents, (iii) a dosing ratio for each identified reagent in the subset; identify, based upon the received one or more coating variables, a first ratio of polymer reagent to use in the subset of reagents; determine a volume of the subset of reagents to dispense, wherein the volume depends on the received environmental data for the paint application area, and the one or more end-user supplied application variables; upon receipt of user confirmation, dispense through the dispenser apparatus an effective amount of each identified reagent of the subset and in the determined volume.

In a thirty-third aspect, in the dispensing machine as recited in any of the thirty-second aspect, the plurality of containers can further include one or more containers of crosslinking reagent. In a thirty-fourth aspect, in the dispensing machine as recited in any one of the thirty-second through thirty-third aspects, the dispensing machine is further configured to: in response to the received set of coating variables, dispense multiple physical reagents. In a thirty-fifth aspect, the dispensing machine as recited in any one of the thirty-second through thirty-fourth aspects, the multiple physical containers comprise multiple containers of coating reagents within a single container; and wherein the polymer reagent is maintained physically separate from a crosslinking reagent, or other of the identified reagents, such that at least the polymer reagent and the crosslinking reagent are maintained in an unreacted state. In a thirty-sixth aspect, in the dispensing machine as recited in any one of the thirty-second through thirty-fifth aspects, the dispensing machine is further configured to: dispense into a single container both the polymer reagent and crosslinking reagent in a mixed solution. In a thirty-seventh aspect, in the dispensing machine as recited in any of the thirty-sixth aspect, or any of the thirty-first through thirty-fifth aspects, the dispensing machine is further configured to dispense into the single container any one or more of a catalyst reagent and a reducer reagent.

The present disclosure may be embodied in other specific forms without departing from its spirit or essential characteristics. The described examples are to be considered in all respects only as illustrative and not restrictive. The scope of the present disclosure is, therefore, indicated by the appended claims rather than by the foregoing description. All changes which come within the meaning and range of equivalency of the claims are to be embraced within their scope.

1. A computer-implemented method for dispensing coating reagent to an end-user through a dispenser apparatus, comprising:
receiving, by a computing system, a set of coating variables comprising: (i) data corresponding environmental input corresponding to local environmental data located adjacent a coating application area, and (ii) one or more end-user supplied application variables for applying the coating to an object;
based upon the received coating variables, identifying, by the computing system, (i) a subset of reagents, including at least a polymer reagent for applying a coating to an object, (ii) one or more additional reagents, (iii) a dosing ratio for each identified reagent in the subset;
identifying, by the computing system, based upon the received one or more coating variables, a first ratio of polymer reagent to use in the subset of reagents;
determining, by the computing system, a volume of the subset of reagents to dispense, wherein the volume depends on the received environmental data for the paint application area, and the one or more end-user supplied application variables;
upon receipt of user confirmation, dispensing through the dispenser apparatus, an effective amount of each identified reagent of the subset and in the determined volume.

2. The computer-implemented method as recited in claim 1, further comprising:
identifying, by the computing system, a second ratio of crosslinking reagent as part of the one or more additional reagents;
determining, by the computing system, a plurality of types of the crosslinking reagent to be used; and
determining, by the computing system, a plurality of types of the polymer reagent to be used.

3. The computer-implemented method as recited in claim 1, further comprising:
receiving the environmental data from one or more environmental sensors connected over a network;
wherein the one or more environmental sensors are positioned remote of the dispenser apparatus.

4. The computer-implemented method as recited in claim 1, further comprising identifying, by the computing system, the following additional reagents:
a third ratio of catalyst reagent; and
a fourth ratio of reducer reagent;
wherein:
each of the first, second, third, and fourth ratios are determined from the received one or more coating variables; and
the reducer reagent has an evaporation rate characterized as slow, medium, or high.

5. The computer-implemented method as recited claim 1, wherein:
the object comprises a vehicle;
the coating application variable received from the end-user defines a make and model of the vehicle; and
the end-user supplied application variables include a desired physical property of the coating once applied to the object.

6. The computer-implemented method as recited in claim 5, wherein the desired physical property comprises any one or more of (i) smoothness, (ii) glossiness, (iii) texture, and/or (iv) film build.

7. The computer-implemented method as recited in claim 5, wherein:
the desired physical property comprises any one or more of (i) polish-ability, (ii) sand-ability, and (iii) substrate type; and
the substrate type comprises plastic, and/or metal.

8. The computer-implemented method as recited in claim 5, wherein the desired property comprises:
(i) speed of application of the coating or speed of cure of the coating on the object; and
(ii) whether the coating will be air dried or baked.

9. The computer-implemented method as recited in claim 5, wherein the desired property:
(i) comprises any one or more of size, or object size;
(ii) designates the coating as a single layer or multi-layer coating; or
(iii) comprises a desired volume of coating mixture.

10. The computer-implemented method as recited in claim 1, wherein the environmental data correspond comprise at least one of the following variables for the paint application area: (i) temperature, (ii) humidity, and (iii) atmospheric pressure.

11. The computer-implemented method as recited in claim 2, further comprising:
dispensing the subset of reagents as a mixture corresponding to the identified first ratio and second ratio; and
displaying a time limit during which the subset of reagents are to be applied to the object when mixed.

12. The computer-implemented method as recited in any of claims 2, further comprising:
based on the environmental input, dispensing the subset of reagents according to the first ratio and the second ratio into one or more physical containers in which the crosslinking reagent and polymer reagent are unmixed, and are physically separated from reaction with one another.

13. The computer-implemented method as recited in claim 1, further comprising:
receiving the end-user supplied coating variables over the internet from a geographically remote location.

14. A coating composition made using the computer-implemented method recited in claim 1, the coating composition further comprising:
a volume in an amount, the volume having a plurality of reagents, wherein the plurality of reagents include:
(i) one or more types of polymer reagent to use, and an effective amount thereof;
(ii) one or more types of crosslinker reagent to use, and an effective amount thereof;
(iii) one or more types of catalyst reagent to use, and an effective amount thereof, and
(iv) one or more types of reducer reagent to use, and an effective thereof;
wherein, the volume amount and effective amounts of each of the plurality of reagents is determined from:
the end-user supplied coating application variables; and
the environmental data in the form of temperature, pressure, and humidity data received from one or more environmental sensors.

15. The coating composition as recited in claim 14, wherein:
the one or more types of polymer reagent further comprise a plurality of additives;
the one or more types of polymer reagents and the plurality of additives mixed in a polymeric reagent solution;
the polymer reagent comprises a clearcoat; and
the polymer reagent further comprises one or more additives including any one or more of (i) an ultra-violet light absorber, and (ii) a hindered-amine light stabilizer; and
the polymeric reagent solution is adjusted for a desired viscosity to be dispensed.

16. The coating composition as recited claim 14, wherein:
the crosslinker reagent comprises a solution that includes the effective amount of crosslinker and one or more solvents; and
the crosslinker reagent solution is adjusted for a desired viscosity to be dispensed.

17. The coating composition of claim 14, wherein:
the catalyst reagent comprises a solution that includes the effective amount of catalyst and one or more solvents;
the catalyst reagent solution further comprises any one or more of: (iii) a catalyst modulator; or (iv) a catalyst inhibitor;
the effective amount of each catalyst reagent depends on the environmental sensor data and user-defined coating application variables;
the reducer reagent comprises a solution that includes a plurality of solvents; and
the plurality of solvents differ by evaporation rate.

18. A dispensing machine configured to provide ready to use packages of coating reagents in a customized amount, comprising:
a processor;
a plurality of containers for various reagents comprising a container of at least polymer reagents, and one or more additional reagents, wherein each container of the plurality is physically sealed from interaction with each other; and
a computer-readable storage medium comprising computer-executable instructions stored that, when executed, cause the processor of the dispensing machine to perform the following:
receive a set of coating variables comprising: (i) data corresponding environmental input corresponding to local environmental data located adjacent a coating application area, and (ii) one or more end-user supplied application variables for applying the coating to an object;
based upon the received coating variables, identify (i) a subset of reagents, including at least a polymer reagent for applying a coating to an object, (ii) one or more additional reagents, (iii) a dosing ratio for each identified reagent in the subset;
identify, based upon the received one or more coating variables, a first ratio of polymer reagent to use in the subset of reagents;
determine a volume of the subset of reagents to dispense, wherein the volume depends on the received environmental data for the paint application area, and the one or more end-user supplied application variables;
upon receipt of user confirmation, dispense through the dispenser apparatus an effective amount of each identified reagent of the subset and in the determined volume.

19. The dispensing machine as recited in claim 18, wherein:
the plurality of containers further comprises one or more containers of crosslinking reagent; and
in response to the received set of coating variables, dispense multiple physical reagents.

20. The dispensing machine as recited in claim 18, wherein:
the multiple physical containers comprise multiple containers of coating reagents within a single container;
wherein the polymer reagent is maintained physically separate from a crosslinking reagent, or other of the identified reagents, such that at least the polymer reagent and the crosslinking reagent are maintained in an unreacted state; and
the dispensing machine is further configured to:
dispense into a single container both the polymer reagent and crosslinking reagent in a mixed solution; and
dispense into the single container any one or more of a catalyst reagent and a reducer reagent.
